(19) United States
(12) Patent Application Publication
(10) Pub. No.: US 2012/0016688 A1
(43) Pub. Date: Jan. 19, 2012

(54) METHOD AND APPARATUS FOR ROUTING A PATIENT TO A HEALTH CARE PROVIDER AND LOCATION

(75) Inventors: Brian William Perrin, American Fork, UT (US); Brett Cornell Gerlach, Eagle Mountain, UT (US)

(73) Assignee: BREVIUM, INC., Eagle Mountain, UT (US)

(21) Appl. No.: 12/837,426

(22) Filed: Jul. 15, 2010

(51) Int. Cl. G06Q 50/00

(52) U.S. Cl. 705/2

(57) ABSTRACT

A method and apparatus for identifying the best provider and location to treat a patient using standard billing and other practice management system (“PMS”) data, combined with provider, location and patient type preferences, so that exactly those patients matching said preferences will be contacted and invited to make an appointment.

### TECHNICAL FIELD OF THE INVENTION

The present invention relates to a method and apparatus for internal marketing, and more particularly, to a method and apparatus for identifying patients who are due for a health care appointment and facilitating contact with those patients to schedule the appointment.

### BACKGROUND OF THE INVENTION

A health care practice may include a variety of providers of health care services. The providers within a practice may include specialists and sub-specialists, each of which must be matched to one or more conditions for which a patient requires treatment. Properly scheduling appointments for patients with the providers of the practice often requires determining which providers should treat a particular patient, and in what order. For example, a cardiologist may refer a patient to a cardiovascular surgeon to determine whether a surgical procedure is necessary. If surgery is not necessary, then the cardiologist may want to see the patient back in the office after the appointment with the surgeon. If surgery is necessary, then the surgeon may want to schedule a post-operative appointment with the patient. The complexity of scheduling increases with the size of the practice and the conditions of the patient being treated. To further complicate matters, new providers join the practice and existing providers leave, making it necessary to ask patients to see a different provider than they have seen in the past. In addition, some providers may be very busy, while others are not, making it necessary to ask patients to move from one provider to another in order to be seen sooner.

A health care practice may also provide health care services at a variety of locations, such as hospitals, clinics, and doctors' offices. Some locations may better than other locations for a particular patient. To further complicate matters, providers may stop practicing at a particular location while continuing to practice at a different location, making it necessary to either ask the patient to see a different provider or follow the provider to the new location. The preference of the patient may depend on how far it is between locations.

Previous inventions have focused on the accurate identification of patients needing a healthcare appointment, and the means of tracking efforts to contact them. However, these solutions fall short for practices requiring a variety of simultaneous approaches to data mining based on provider preferences. Therefore, the healthcare industry needs a system for accurately determining which provider and location should treat a given patient based on configured preferences and data readily available in most offices.

### SUMMARY OF THE INVENTION

An object of the present invention is to use healthcare data from a database combined with configurable settings to determine which patients should be invited to make an appointment, and which provider and location to recommend for each patient.

The present invention provides a mechanism for accurately determining whether a patient should be invited to make an appointment with the practice and for determining which provider and location to recommend based on configured preferences and data readily available in most offices. In a typical embodiment, a system uses information about patients and their treatment histories, health care providers, and locations providing health care services, along with preferences for patient types, locations and providers. A set of patient types would be defined according to practice preferences, and a table would be created mapping each patient to zero or more types according to their treatment history or other data. A primary type, secondary type, tertiary type, etc. would be determined per patient.

Given a patient of a given primary type, the invention would determine a starting provider and starting location from which a patient can be routed to a recommended provider and location. A preferred provider and/or location may sometimes be found in the PMS patient demographic data. The invention may also allow configuration of a preferred location or a location based on a patient's address or zip code. If a preferred location or a location based on a portion of a patient's address is has not been configured, the invention would scan the patient history looking at each past event that is relevant to the particular patient type. From those events the invention can determine the most recent provider and location, or the most frequent provider and location, preferring, where possible, providers and/or locations which are currently scheduling or “active.”

Because it is preferred to start the routing process from a most recent active provider and location, it is helpful to first resolve or “de-dupe” any duplicate provider or location identifiers (“codes”) so that the true active status may be known regardless of the currency of the particular code. It is likewise desirable to de-dupe patient codes for obtaining accurate patient history.

Given, then, a patient of a given primary type, starting from a given provider and location, the invention determines a best recommended provider and location for that patient based on which patient types each provider wants to treat, which locations are close to each other, and/or which schedules should be filled, as is described in further detail with respect to the drawings.

The foregoing has outlined rather broadly the features and technical advantages of the present invention in order that the detailed description of the invention that follows may be better understood. The system as described herein includes several inventive aspects, and not all embodiments will include all the features described. Moreover, it should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention and the advantages thereof, reference is now made to the following detailed description taken in conjunction with the accompanying drawings, wherein:

FIG. 1 is a block diagram showing the patient reactivation system 100 and a practice management system 102 which can be used together to implement the invention;

FIG. 2 is a diagram showing an exemplary schedules table in accordance with a preferred embodiment of the present invention;

FIG. 3 is a diagram showing an exemplary locations table in accordance with a preferred embodiment of the present invention;

FIG. 4 is a diagram showing an exemplary providers and patient types table in accordance with a preferred embodiment of the present invention;

FIG. 5A is a flowchart showing an exemplary method for determining a recommended provider and location for each patient in accordance with a preferred embodiment of the present invention; and

FIG. 5B is a continuation of the flowchart in FIG. 5A showing an exemplary method for determining a recommended provider and location for each patient in accordance with a preferred embodiment of the present invention.

### DESCRIPTION OF THE PREFERRED EMBODIMENTS

In order for a health care practice to be able to identify patients requiring care and invite them to make an appointment, a patient reactivation system should be able to correctly determine which provider a patient should be invited to see. In order to provide choices to the health care practice about which schedules should be filled and which types of patients (based on their condition(s)) each provider wants added to their schedules, the system should be able to accurately predict which provider will see them. In order to help schedulers make decisions in harmony with the policies of the practice, the system should accurately suggest a provider and location for each patient based on those policies. In order to inform a patient why they are being contacted (i.e., which provider is inviting them to make an appointment and for what reason), the system must accurately predetermine the parameters used to initiate the contact. In order to be able to accurately charge fees according to provider(s) and/or location(s) using the system, it is important to know which provider and/or location a patient should be invited to see. Providing control over the types of patients contacted for each provider can enhance the value of a patient reactivation system. Without it, a busy surgeon who wants to avoid more clinic time while seeing more surgical candidates and a new provider wanting to fill his underutilized schedule with any type of patient could not both be satisfied.

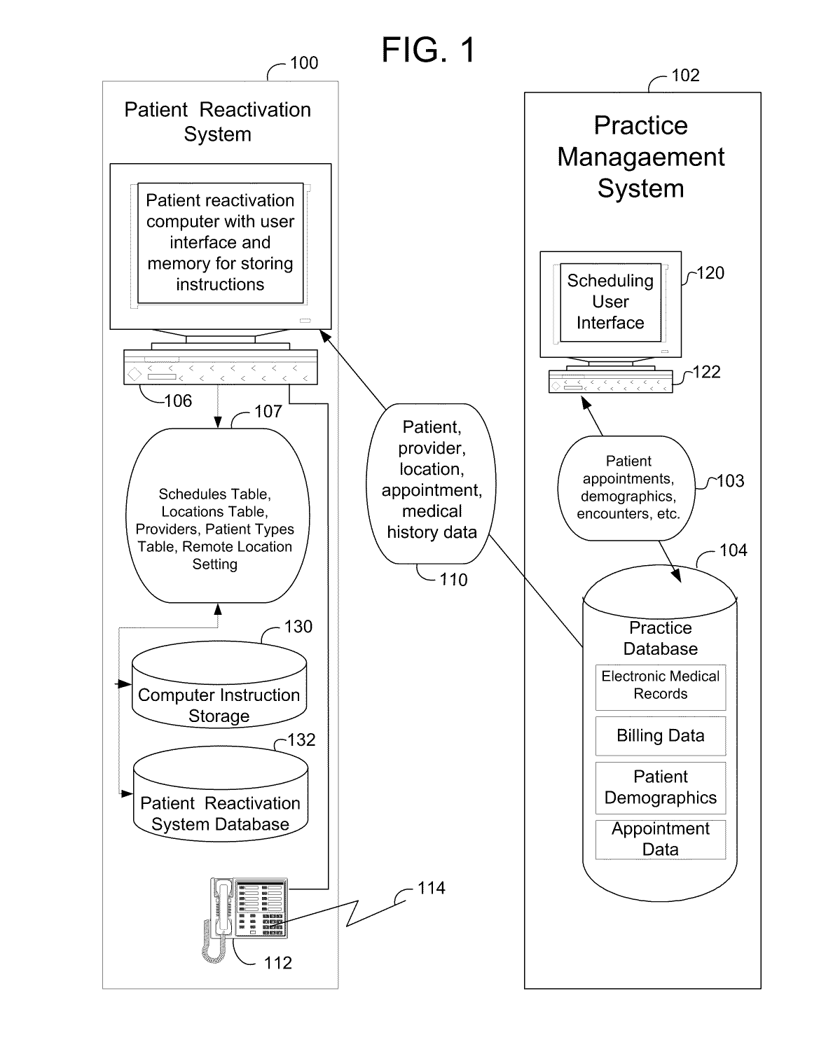

A preferred embodiment comprises a computer system programmed to carry out specific steps as part of a patient reactivation system software operating on the computer system. FIG. 1 is a block diagram showing the patient reactivation system 100 and a practice management system 102 which can be used together to implement the invention. Patient reactivation system 100 includes a patient reactivation system user computer 106 with a user interface, including, for example, a video display by which a user can view information presented by the system about patients to be called, and a keyboard, mouse, or other device by which the user can enter data into a user computer on the system. In some embodiments, calls to patients may be automated, and made without human assistance. In preferred embodiments, calls are made by a human user in order to better relate to the patients being called. The human user uses a telephone 112 connected to a public telephone network 114 or uses a telephone interface on computer 106. In other embodiments, patients can be contacted by other methods, such as email, either automatically by the computer or by a human user of the system. Patient reactivation system 100 also includes computer instruction storage 130 and patient reactivation system database 132. Patient reactivation system database 132 stores lists of patients to contact and information about the patients necessary to make the contact. Computer instruction storage 130 stores computer instructions for executing the steps of the present invention. Computer instruction storage 130 and patient reactivation system database 132 may be stored on user computer 106 or on a network storage location. The invention includes computer readable media, such as optical or magnetic media, having stored thereon computer instruction for executing steps of the invention. The term “user” or “practice” when describing a person performing steps indicates a person working on behalf of a health care practice. The patient reactivation system 100 interfaces with practice management system 102, which includes a scheduling computer with a scheduling user interface 120 and a management system database 104 that typically includes billing codes. The billing codes can be used to determine when additional visits are required.

Scheduling computer 122 draws patient appointments 103 and other data from the practice database 104, and writes new appointments 103 and other data into the practice database 104. The patient reactivation system 100 determines, as described for example in U.S. patent application Ser. No. 11/938,087, entitled “Method and Apparatus for Identifying Patients Overdue for an Appointment Using Standard Healthcare Billing Data,” which is hereby incorporated by reference, which patients should be contacted 110 and prompts one or more users to contact these patients.

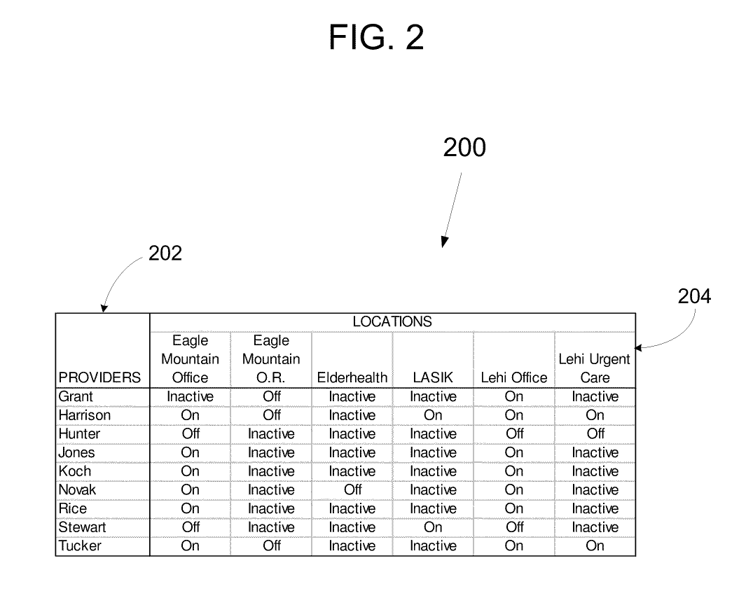

In the preferred embodiment of the present invention, each of the three tables represented in FIGS. 2-4 is stored as a list in the form “for each unique combination of set A paired with set B, setting C,” and is represented visually in the form “for each cell at row A and column B, setting C,” with setting values represented by the text in each cell as shown. Tables 107 can be stored into the patient reactivation system database 132. The patient reactivation system 100 queries the patient reactivation system database 132 to determine which provider and which location to recommend to a patient when contacting the patient to schedule a future appointment.

Turning now to FIG. 2, a diagram is shown of an exemplary schedules table in accordance with a preferred embodiment of the present invention. Schedules table 200 pairs providers in rows of column 202 with the locations in columns of row 204. A provider is a member of the practice who can provide health care services to patient. A patient is a person in need of health care services, such as the health care services provided by the providers of the practice. A location is a health care facility where a patient can receive health care services from a provider. Each provider-location pair corresponds to a cell in schedules table 200. Each cell includes a setting that indicates whether the provider associated with the cell is currently scheduling appointments at the location associated with the cell, and whether the schedule associated with the provider at that location is eligible for patient reactivation. This information can be used to determine which providers and locations are active. In schedules table 200, cells having a setting of “Inactive” indicate that the provider does not have an active schedule at the corresponding location. Cells having a setting of “Off” indicate that the provider has an active schedule at the corresponding location, but the schedule is ineligible for patient reactivation. Cells having a setting of “On” indicate that the provider has an active schedule at the corresponding location and that patients routed to that provider and location should be contacted for reactivation.

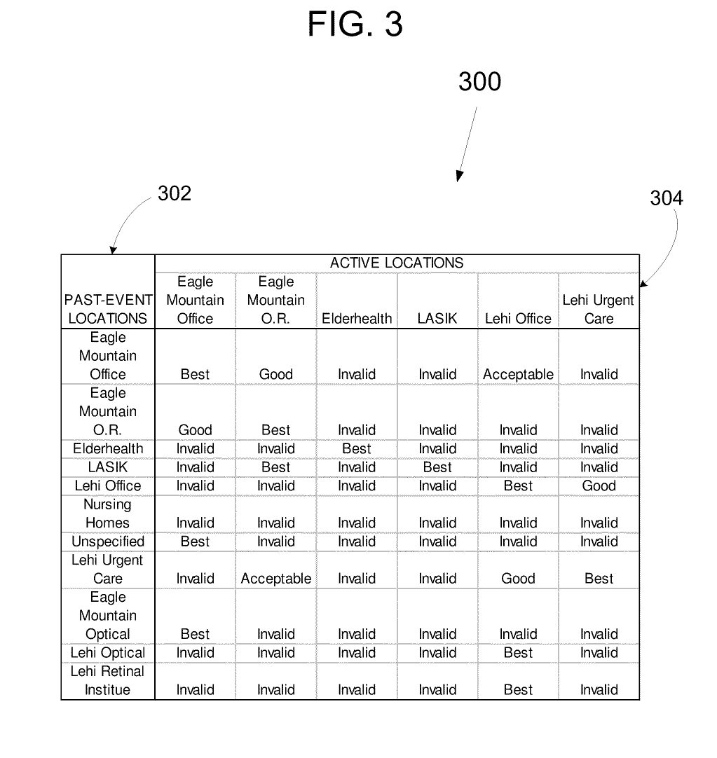

Turning now to FIG. 3, a diagram is shown of an exemplary locations table in accordance with a preferred embodiment of the present invention. Locations table 300 pairs past-event locations in rows of column 302 with active locations in columns of row 304. A past-event location is a location where the patient received health care services from a provider. A past-event location is preferably recorded in medical history data 110 associated with the patient, such as in a billing record in practice database 104 of practice management system 102, and is retrievable by patient reactivation system 100. Past-event locations may include locations that are no longer served by providers of the practice. In this case, a patient may need to be routed to a different location to be treated by a provider of the practice. An active location is a location that is presently scheduling patients for providers of the practice and a location to which a patient may be routed by the patient reactivation system. A past-event location and an active location may be the same location, that is, they are not mutually exclusive. The distinction is that the past-event location represents a location where a patient was treated in the past, and an active location is a location where the patient can be routed for future treatment. Each past-event location can be mapped to an active location according to the setting in the cell in locations table 300 that corresponds to the past-event location and the active location. Cell settings in table 300 can indicate which past-event locations (if any) are close enough to each active location to route the patient for treatment using priorities, such as “Best”, “Good”, “Acceptable” and “Invalid”. An active location having a setting of “Best” represents the highest routing priority for a past-event location. An active location having a setting of “Good” is not as preferable for routing a patient that was treated at the corresponding past-event location as an active location having a setting of “Best”, but is preferred over an active location having a setting of “Acceptable” or “Inactive”. An active location having a setting of “Good” or “Acceptable” is not as preferable for routing a patient that was treated at the corresponding past-event location as an active location having a setting of “Best”, but is preferred over an active location having a setting of “Invalid”. An active location having a setting of “Invalid” is not a valid location to route a patient that was treated at the corresponding past-event location.

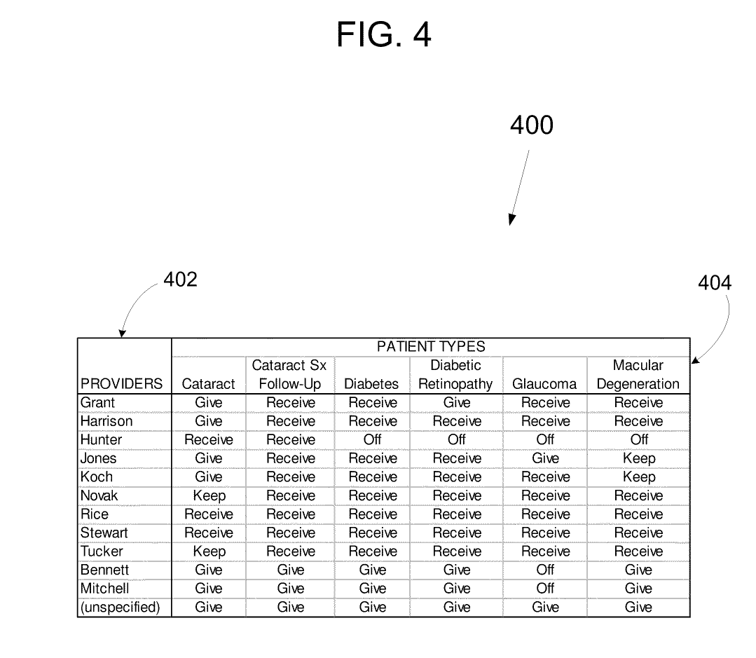

Turning now to FIG. 4, a diagram is shown of an exemplary providers and patient types table in accordance with a preferred embodiment of the present invention. Providers and patient types table 400 pairs providers in rows of column 402 with patient types in columns of row 404. A patient type can be any attribute of a patient for which a provider can indicate a transfer status in the patient reactivation system. For example, a patient type can be such things as a medical condition which one or more of the providers of the practice is capable of treating, an ignored reminder for follow-up care, or a recently missed appointment. Patient types can be determined by patient reactivation system 100 from data in practice management system 102. For example, a patient type can be determined from events in medical history data 110 associated with the patient, such as diagnoses, procedures, visit dates or expected return dates, as stored in billing data, an electronic medical record, or other data in practice database 104 of practice management system 102.

Each provider-patient type pair is associated with a setting called a transfer status. The transfer status indicates how a provider would like to have patient reactivation system 100 route patients based on the corresponding patient type. In a preferred embodiment, each provider may be associated with one of four transfer statuses: “Receive,” “Keep,” “Give,” or “Off”. A transfer status of “Receive” indicates that a provider wants existing patients of the provider having the corresponding patient type to be routed to the provider, and that the provider will also schedule appointments for patients having the corresponding patient type who are associated with another provider. A transfer status of “Keep” indicates that a provider wants existing patients of the provider having the corresponding patient type to be routed to the provider, but that the provider will not schedule appointments for patients having the corresponding patient type who are associated with another provider. A transfer status of “Give” indicates that a provider wants existing patients of the provider having the corresponding patient type to be routed to another provider. A transfer status of “Off” indicates that the provider does not want patient reactivation system 100 to contact the patients of the provider having the corresponding patient type. Providers who are no longer scheduling at the practice (such as Bennett in FIG. 4, who is absent in FIG. 2) cannot have a transfer status of “Receive” or “Keep.”

Before determining patient routing, a preferred embodiment of the invention would take preliminary steps to condition the data retrieved from the practice management system for use in the patient reactivation system. A preliminary step can include resolving duplicate provider codes and location codes. A preliminary step can include resolving duplicate patient codes. A preliminary step can include determining which events in medical history data 110 correspond to each available patient type. A preliminary step can also include an attempt to determine a provider or location code from any corresponding notes in medical history data 110 if no provider code or location code is specified for a particular event.

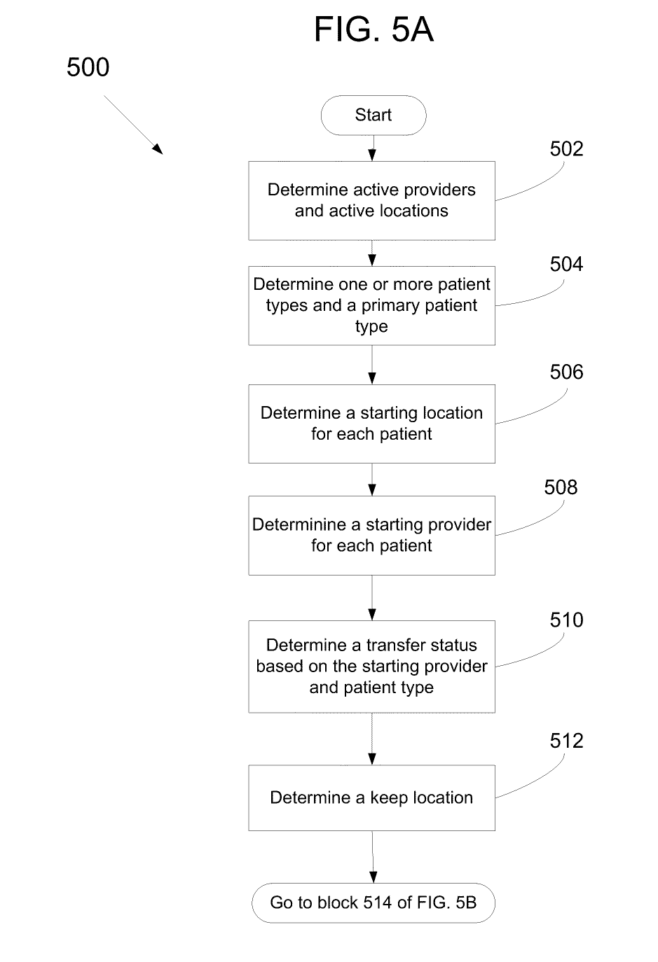

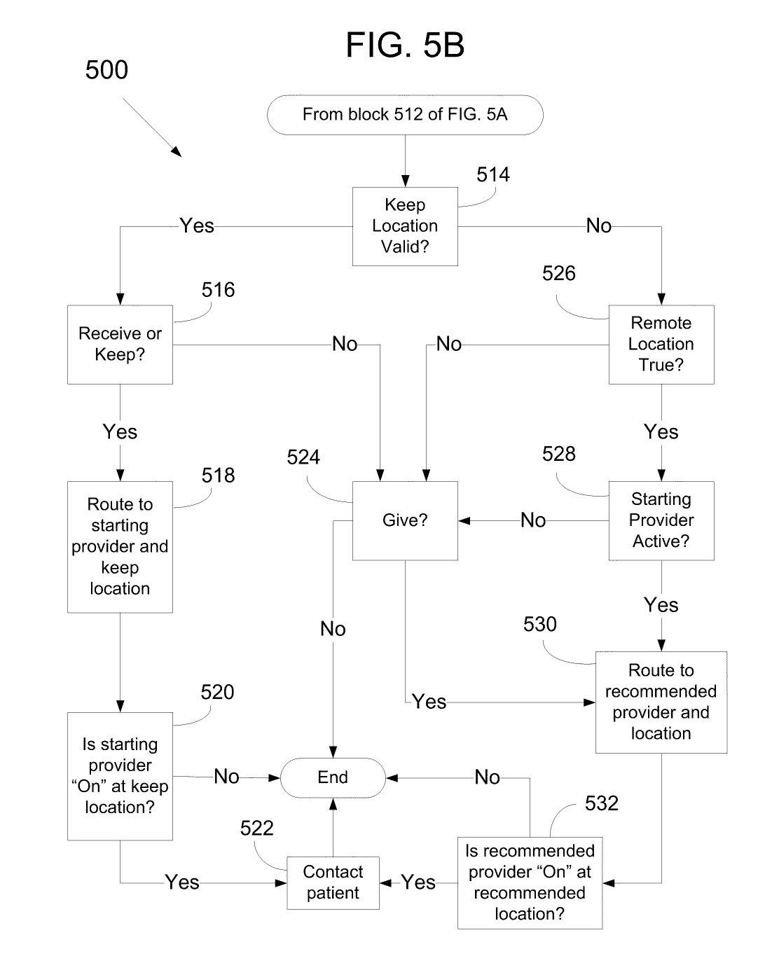

The invention, having collected the above-mentioned preferences, and having taken any preliminary steps, would then determine a recommended provider and location for each patient. Turning now to FIG. 5A, flowchart 500 is shown depicting an exemplary method for determining a recommended provider and location for each patient. At block 502, patient reactivation system 100 determines which providers and locations are active based on whether there is at least one active schedule for that provider or location. An active schedule can determined from schedule table 200 as a cell having a setting of “On” or “Off” but not “Inactive”. At block 504, patient reactivation system 100 determines one or more patient types for the patient based on medical history data 110 associated with patient in the practice management system 102. No more than one of the patient types is designated in patient reactivation system 100 as a primary patient type of the patient.

At block 506, patient reactivation system 100 determines a starting location for each patient based on medical history data 110 associated with the patient in practice management system 102. For example, if there's a preferred location for the patient in medical history data 110, then select the preferred location as the starting location. Otherwise, if there's a configuration that maps at least a portion of the patient's address to a location, such as a zip code or a distance calculated by a mapping service, then select the location mapped to the patient's address as the starting location. Otherwise, determine the best location from medical history data 110, preferring active locations to inactive, preferring recent history to older history, and preferring history corresponding to the primary type to that corresponding to the secondary type, etc. Otherwise the starting location is unspecified.

At block 508, patient reactivation system 100 determines a starting provider for each patient based on medical history data 110 associated with the patient in practice management system 102. For example, if there's a preferred provider for the patient in medical history data 110, then select the preferred provider as the starting provider. Otherwise, determine the best provider from medical history data 110, preferring active providers to inactive, preferring recent history to older history, and preferring history corresponding to the primary type to that corresponding to the secondary type, etc. Otherwise the starting provider is unspecified.

At block 510, patient reactivation system 100 determines a “transfer status” based on the starting provider and patient type. A transfer status (e.g., “Receive”, “Keep”, “Give”, or “Off”) can be determined from patient and patient type table 400 by looking up the status in the cell corresponding to the starting provider and the patient type. At block 512, patient reactivation system 100 determines a “keep location”. A keep location can be determined by finding the row in location table 300 corresponding to the starting location. After finding the row in the location table 300, determine the set of active locations for the starting provider. The set of active locations for the starting provider can be determined from “On” or “Off” cells in schedule table 200. From the set of active locations, determine a set of locations (if any) on the row in location table 300 corresponding to the starting provider that share the highest valid priority (i.e., “Best”, then “Good”, then “Acceptable”). Select as the keep location any location from the set of locations that share the highest valid priority, preferring “On” locations to “Off” location in schedule table 200, then preferring, if available, the starting location.

After block 512, flowchart 500 continues at block 514 of FIG. 5B. At block 514, patient reactivation system 100 determines whether the keep location is a valid location (“on” or “off” in schedule table 200). If the “keep location” is valid at block 514, patient reactivation system 100 proceeds to block 516. At block 516, patient reactivation system 100 determines whether the transfer status is one of “Receive” or “Keep”. If the transfer status is not “Receive” or “Keep” at block 516, for patients of the primary patient type, patient reactivation system 100 proceeds to block 524. If the transfer status is “Receive” or “Keep” at block 516, for patients of the primary patient type, patient reactivation system 100 proceeds to block 518. At block 518, patient reactivation system 100 routes the patient to the starting provider and the keep location. At block 520, patient reactivation system 100 determines whether the schedule for the starting provider at the keep location is “On” in schedule table 200. If the schedule for the starting provider at the keep location is not “On” in schedule table 200, then the patient is disqualified from being contacted to make an appointment and the process ends. If the schedule for the starting provider at the keep location is “On” in schedule table 200, then the patient may be contacted at block 522 to make an appointment and the process ends.

Returning to block 514, if the keep location is not a valid location, patient reactivation system 100 proceeds to block 526. At block 526, patient reactivation system 100 determines whether a remote location setting is true. The remote location setting can be a boolean setting and can be applied globally or per location. A value of true would indicate that when a provider is unreachable per location settings, the patient “belongs to the location” and would be transferred to a new reachable provider regardless of the corresponding setting in providers and patient types table 400. If the remote location setting is true, patient reactivation system 100 proceeds to block 528. At block 528, patient reactivation system 100 determines whether the starting provider is an active provider. If the starting provider is not an active provider, patient reactivation system 100 proceeds to block 524.

At block 524, patient reactivation system 100 determines whether the transfer status is “Give”. If the transfer status is not “Give” then the patient is disqualified from routing and the process ends. If the transfer status is “Give” then patient reactivation system 100 proceeds to block 530. Returning to block 528, if the starting provider is an active provider, patient reactivation system 100 also proceeds to block 530. In effect, if the “Remote location” setting is true, and the “keep location” is invalid, and the starting provider is active, then it is the same as setting transfer status to “Give.”

At block 530, patient reactivation system routes the patient to a recommended provider and location. Patient reactivation system 100 can recommend a provider and location by finding the row in location table 300 corresponding to the starting location. That is, patient reactivation system 100 determines a set of active locations comprising each active location that is currently scheduling for the starting location. Patient reactivation system 100 then determines the set of providers that have both a transfer status of “Receive” for the given patient type (“Receive” in provider and patient type table 400), and at least one schedule “on” in schedule table 200 at a valid location (best, good, or acceptable) from the above-determined row in location table 300. Then, from that set of providers, patient reactivation system 100 determines the set of locations that are “on” in schedule table 200. Then, from that set of locations, patient reactivation system 100 determines the set of locations that share the highest priority on the above-determined row of location table 300. If there is no valid location, patient reactivation system 100 recommends no provider or location, and finishes. Otherwise, patient reactivation system 100 can recommend any location from the set of highest-priority locations, preferring, if available, the starting location. Then, having this recommended location, patient reactivation system 100 can recommend any provider from the above-determined set of providers having the recommended location “on” in schedule table 200. After block 530, patient reactivation system proceeds to block 532,

At block 532, patient reactivation system 100 determines whether the schedule for the recommended provider at the recommended location is “On” in schedule table 200. If the schedule for the recommended provider at the recommended location is not “On” in schedule table 200, then the patient is disqualified from being contacted to make an appointment and the process ends. If the schedule for the recommended provider at the recommended location is “On” in schedule table 200, then the patient may be contacted at block 522 to make an appointment and the process ends.

While the foregoing has described the invention in detail with respect to one or more exemplary embodiments, it should be understood that various changes, substitutions and alterations could be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A method for routing patients within a practice of health care providers, the method comprising:
determining a set of active providers from a plurality of providers based on whether a provider has at least one active schedule in a practice management system;
determining a set of active locations from a plurality of locations based on whether a location has at least one active schedule in the practice management system;
determining one or more patient types for the patient based on data associated with patient in the practice management system, wherein no more than one of the patient types is designated in a patient reactivation system as a primary patient type of the patient;
determining a first location based on data associated with the patient in the practice management system;
determining a first provider based on data associated with the patient in the practice management system;
determining a transfer status associated with the first provider, the transfer status indicating a scheduling preference of the first provider based on the primary patient type of the patient;
in response to the transfer status indicating that the first provider does not want existing patients to be contacted, disqualifying the patient in the patient reactivation system from being contacted to schedule a future appointment;
in response to the transfer status indicating that, for patients of the primary patient type, the first provider wants existing patients of the first provider to be routed to the first provider:
determining a second location to route the patient to based on the first location and data in the patient reactivation system;
routing the patient to the first provider at the second location;
in response to the transfer status indicating that the first provider wants existing patients of the first provider routed to a second provider:
determining a second location to route the patient to based on the first location and data in the patient reactivation system;
determining a second provider to route the patient to based on the primary patient type and data in the patient reactivation system; and
routing the patient to the second provider at the second location.

2. The method of claim 1, wherein the step of determining the first location for the patient further comprises:
determining whether a preferred location is associated with the patient in the practice management system;
in response to determining that a preferred location is associated with the patient in the practice management system, selecting the preferred location as the first location;
in response to determining that a preferred location is not associated with the patient in the practice management system, determining whether a medical history associated with the patient includes any locations in the set of locations;
in response to determining that the medical history associated with the patient includes one or more locations in the set of locations, selecting a first location from the medical history based on one or more of the following preferences:
active locations are preferred for selection over inactive locations;
locations where the patient has been treated more recently are preferred for selection over locations where the patient has been treated less recently; and
locations treating the patient type of the patient having a higher predetermined priority are preferred for selection over locations treating patient types having a lower predetermined priority;
in response to determining that the medical history of the patient does not include any locations in the set of locations, setting the first location as unspecified.

3. The method of claim 1, the step of determining the first provider for the patient further comprising:
determining whether a preferred provider is associated with the patient in the practice management system;
in response to determining that a preferred provider is associated with the patient in the practice management system, selecting the preferred provider as the first provider;
in response to determining that a preferred provider is not associated with the patient in the practice management system, determining whether a medical history associated with the patient includes any providers in the set of providers;
in response to determining that the medical history associated with the patient includes one or more providers in the set of providers, selecting a first provider from the medical history based on one or more of the following preferences:
active providers are preferred for selection over inactive providers;
providers who have treated the patient more recently are preferred for selection over providers who have treated the patient less recently; and
providers treating the patient type of the patient having a higher predetermined priority are preferred for selection over providers treating patient types having a lower predetermined priority;
in response to determining that the medical history of the patient does not include any providers in the set of providers, setting the first provider as unspecified.

4. The method of claim 1, the step of determining the first provider for the patient further comprising:
determining whether a preferred provider is associated with the patient in the practice management system;
in response to determining that a preferred provider is associated with the patient in the practice management system, selecting the preferred provider as the first provider;
in response to determining that a preferred provider is not associated with the patient in the practice management system, determining whether a medical history associated with the patient includes any providers in the set of providers;
in response to determining that the medical history associated with the patient includes one or more providers in the set of providers, selecting a first provider from the medical history based on one or more of the following preferences:
active providers are preferred for selection over inactive providers;
providers who have treated the patient more frequently are preferred for selection over providers who have treated the patient less frequently; and
providers treating the patient type of the patient having a higher predetermined priority are preferred for selection over providers treating patient types having a lower predetermined priority;
in response to determining that the medical history of the patient does not include any providers in the set of providers, setting the first provider as unspecified.

5. The method of claim 1, the step of determining the second location in response to the transfer status indicating that the first provider wants appointments for existing patients of the first provider to be scheduled with the first provider further comprising:
determining a second set of active locations comprising each active location that is currently scheduling for the first location;
determining a subset of the set of active locations, each active location corresponding to the first provider;
determining a set of active locations comprising the intersection of the subset of active locations corresponding to the first location and the subset of active locations corresponding to the first provider; and
selecting the second location from the set of active locations comprising the intersection of the subset of active locations corresponding to the first location and the subset of active locations corresponding to the first provider, wherein the selection of the second location is based on a predetermined priority of locations in the set active locations, and wherein the predetermined priority of the first location is the highest priority.

6. The method of claim 1, the step of determining the second provider and the second location in response to the transfer status indicating that the first provider wants appointments for existing patients of the first provider to be scheduled with a second provider further comprising:
determining a second set of active locations comprising each active location that is currently scheduling for the first location;
determining a second set of active providers comprising each active provider that has a transfer status indicating that the provider will schedule appointments for patients of the primary patient type associated with another provider; and
selecting as the second location a location from the second set of active locations at which at least one of the second set of active providers is actively scheduling patients, giving preference to the locations having the highest priority;
selecting as the second provider a provider from the second set of active providers that is currently scheduling appointments at the second location.

7. The method of claim 1, wherein the determination of the first location and/or the determination of the second location is based on at least a portion of an address associated with the patient being mapped to a provider location.

8. The method of claim 1, further comprising, prior to determining the set of active providers:
resolving any duplicate providers from the set of health care providers;
resolving any duplicate locations from the set of locations that provide health care services; and/or
resolving any duplicate patient codes from data of the practice management system.

9. The method of claim 1, wherein the step of determining a first provider further comprises:
determining whether an event in a medical history of the practice management system associated with the patient includes a provider code;
in response to determining that the event does not include a provider code, determining provider information from any notes in the medical history that correspond to the event; and
in response to determining that the event notes include provider information, associating the corresponding provider with the event.

10. The method of claim 1, wherein the step of determining a first location further comprises:
determining whether an event in a medical history of the practice management system associated with the patient includes a location code;
in response to determining that the event does not include a location code, determining location information from any notes in the medical history that correspond to the event; and
in response to determining that the event notes include location information, associating the corresponding location with the event.

11. The method of claim 1, wherein the patient is disqualified in the patient reactivation system from being contacted for scheduling a future appointment in response to an indication that the provider and location to which the patient is routed does not represent a schedule which should be filled by the patient reactivation system.

12. The method of claim 1, further comprising, prior to routing the patient to a provider and/or location:
determining whether a remote location indication is associated with the first location, wherein the remote location indication indicates that treating the patient at the first location has priority over the first provider treating the patient;
in response to determining that the remote location indication is associated with the first location and the first provider is not presently scheduling appointments at the first location for the primary patient type, routing the patient to the first location and a second provider who is presently scheduling appointments at the first location for the primary patient type.

13. A computer-readable medium encoded with computer-executable instructions for routing patients within a practice of health care providers, the computer-executable instructions, when executed by a processor of a computer, operable to cause the computer to perform the steps of:
determining a set of active providers from the plurality of providers based on whether a provider has at least one active schedule in a practice management system;
determining a set of active locations from the plurality of locations based on whether a location has at least one active schedule in the practice management system;
determining one or more patient types for the patient based on the data associated with patient in the practice management system, wherein no more than one of the patient types is designated in a patient reactivation system as a primary patient type of the patient;
determining a first location based on data associated with the patient in the practice management system;
determining a first provider based on data associated with the patient in the practice management system;
determining a transfer status associated with the first provider, the transfer status indicating a scheduling preference of the first provider based on the primary patient type of the patient;
in response to the transfer status indicating that the first provider does not want existing patients to be contacted, disqualifying the patient in the patient reactivation system from being contacted to schedule a future appointment;
in response to the transfer status indicating that the first provider wants existing patients of the first provider to be routed to the first provider:
determining a second location to route the patient to based on the first location and data in the patient reactivation system;
routing the patient to the first provider at the second location;
in response to the transfer status indicating that the first provider wants existing patients of the first provider routed to a second provider:
determining a second location to route the patient to based on the first location and data in the patient reactivation system;
determining a second provider to route the patient to based on the primary patient type and data in the patient reactivation system; and
routing the patient to the second provider at the second location.

14. The computer-readable medium of claim 13, wherein the instructions for determining the first location for the patient further comprise instructions for:
determining whether a preferred location is associated with the patient in the practice management system;
in response to determining that a preferred location is associated with the patient in the practice management system, selecting the preferred location as the first location;
in response to determining that a preferred location is not associated with the patient in the practice management system, determining whether a medical history associated with the patient includes any locations in the set of locations;
in response to determining that the medical history associated with the patient includes one or more locations in the set of locations, selecting a first location from the medical history based on one or more of the following preferences:
active locations are preferred for selection over inactive locations;
locations where the patient has been treated more recently are preferred for selection over locations where the patient has been treated less recently; and
locations treating the patient type of the patient having a higher predetermined priority are preferred for selection over locations treating patient types having a lower predetermined priority;
in response to determining that the medical history of the patient does not include any locations in the set of locations, setting the first location as unspecified.

15. The computer-readable medium of claim 13, the instructions for determining the first provider for the patient further comprising instructions for:
determining whether a preferred provider is associated with the patient in the practice management system;
in response to determining that a preferred provider is associated with the patient in the practice management system, selecting the preferred provider as the first provider;
in response to determining that a preferred provider is not associated with the patient in the practice management system, determining whether a medical history associated with the patient includes any providers in the set of providers;
in response to determining that the medical history associated with the patient includes one or more providers in the set of providers, selecting a first provider from the medical history based on one or more of the following preferences:
active providers are preferred for selection over inactive providers;
providers who have treated the patient more recently are preferred for selection over providers who have treated the patient less recently; and
providers treating the patient type of the patient having a higher predetermined priority are preferred for selection over providers treating patient types having a lower predetermined priority;
in response to determining that the medical history of the patient does not include any providers in the set of providers, setting the first provider as unspecified.

16. The computer-readable medium of claim 13, the instructions for determining the first provider for the patient further comprising instructions for:
determining whether a preferred provider is associated with the patient in the practice management system;
in response to determining that a preferred provider is associated with the patient in the practice management system, selecting the preferred provider as the first provider;
in response to determining that a preferred provider is not associated with the patient in the practice management system, determining whether a medical history associated with the patient includes any providers in the set of providers;
in response to determining that the medical history associated with the patient includes one or more providers in the set of providers, selecting a first provider from the medical history based on one or more of the following preferences:
active providers are preferred for selection over inactive providers;
providers who have treated the patient more frequently are preferred for selection over providers who have treated the patient less frequently; and
providers treating the patient type of the patient having a higher predetermined priority are preferred for selection over providers treating patient types having a lower predetermined priority;
in response to determining that the medical history of the patient does not include any providers in the set of providers, setting the first provider as unspecified.

17. The computer-readable medium of claim 13, the instructions for determining the second location in response to the transfer status indicating that the first provider wants appointments for existing patients of the first provider to be scheduled with the first provider further comprising instructions for:
determining a second set of active locations comprising each active location that is currently scheduling for the first location;
determining a subset of the set of active locations, each active location corresponding to the first provider;
determining a set of active locations comprising the intersection of the subset of active locations corresponding to the first location and the subset of active locations corresponding to the first provider; and
selecting the second location from the set of active locations comprising the intersection of the subset of active locations corresponding to the first location and the subset of active locations corresponding to the first provider, wherein the selection of the second location is based on a predetermined priority of locations in the set active locations, and wherein the predetermined priority of the first location is the highest priority.

18. The computer-readable medium of claim 13, the instructions for determining the second provider and the second location in response to the transfer status indicating that the first provider wants appointments for existing patients of the first provider to be scheduled with a second provider further comprising instructions for:
determining a second set of active locations comprising each active location that is currently scheduling for the first location;
determining a second set of active providers comprising each active provider that has a transfer status indicating that the provider will schedule appointments for patients of the primary patient type associated with another provider; and
selecting as the second location a location from the second set of active locations at which at least one of the second set of active providers is actively scheduling patients, giving preference to the locations having the highest priority;
selecting as the second provider a provider from the second set of active providers that is currently scheduling appointments at the second location.

19. The computer-readable medium of claim 13, wherein the determination of the first location and/or the determination of the second location is based on at least a portion of an address associated with the patient being mapped to a provider location.

20. The computer-readable medium of claim 13, further comprising instructions for, prior to determining the set of active providers:
resolving any duplicate providers from the set of health care providers;
resolving any duplicate locations from the set of locations that provide health care services; and/or
resolving any duplicate patient codes from data of the practice management system.

21. The computer-readable medium of claim 13, wherein the instructions for determining a first provider further comprise instructions for:
determining whether an event in a medical history of the practice management system associated with the patient includes a provider code;
in response to determining that the event does not include a provider code, determining provider information from any notes in the medical history that correspond to the event; and
in response to determining that the event notes include provider information, associating the corresponding provider with the event.

22. The computer-readable medium of claim 13, wherein the instructions for determining a first location further comprise instructions for:
determining whether an event in a medical history of the practice management system associated with the patient includes a location code;
in response to determining that the event does not include a location code, determining location information from any notes in the medical history that correspond to the event; and
in response to determining that the event notes include location information, associating the corresponding location with the event.

23. The computer-readable medium of claim 13, wherein the patient is disqualified in the patient reactivation system from being contacted for scheduling a future appointment in response to an indication that the provider and location to which the patient is routed does not represent a schedule which should be filled by the patient activation system.

24. The computer-readable medium of claim 13, further comprising instructions for, prior to routing the patient to a provider and/or location:
determining whether a remote location indication is associated with the first location, wherein the remote location indication indicates that treating the patient at the first location has priority over the first provider treating the patient;
in response to determining that the remote location indication is associated with the patient and the first provider is not presently scheduling appointments at the first location for the primary patient type, routing the patient to the first location and a second provider who is presently scheduling appointments at the first location for the primary patient type.

25. A patient reactivation system for routing patients within a practice of health care providers, the practice comprising a plurality of health care providers and a plurality of locations for providing health care services, the system comprising:
a processor;
a memory coupled to the processor, the memory comprising a computer-readable medium encoded with computer-executable instructions that, when executed by a processor of a computer, are operable to cause the computer to perform the steps of:
determining a set of active providers from the plurality of providers based on whether a provider has at least one active schedule in a practice management system;
determining a set of active locations from the plurality of locations based on whether a location has at least one active schedule in the practice management system;
determining one or more patient types for the patient based on the data associated with patient in the practice management system, wherein no more than one of the patient types is designated in a patient reactivation system as a primary patient type of the patient;
determining a first location based on data associated with the patient in the practice management system;
determining a first provider based on data associated with the patient in the practice management system;
determining a transfer status associated with the first provider, the transfer status indicating a scheduling preference of the first provider based on the primary patient type of the patient;
in response to the transfer status indicating that the first provider does not want existing patients to be contacted, disqualifying the patient in the patient reactivation system from being contacted to schedule a future appointment;
in response to the transfer status indicating that the first provider wants existing patients of the first provider to be routed to the first provider:
determining a second location to route the patient to based on the first location and data in the patient reactivation system;
routing the patient to the first provider at the second location;
in response to the transfer status indicating that the first provider wants existing patients of the first provider routed to a second provider:
determining a second location to route the patient to based on the first location and data in the patient reactivation system;
determining a second provider to route the patient to based on the primary patient type and data in the patient reactivation system; and
routing the patient to the second provider at the second location.

26. The system of claim 25, wherein the instructions for determining the first location for the patient further comprise instructions for:
determining whether a preferred location is associated with the patient in the practice management system;
in response to determining that a preferred location is associated with the patient in the practice management system, selecting the preferred location as the first location;
in response to determining that a preferred location is not associated with the patient in the practice management system, determining whether a medical history associated with the patient includes any locations in the set of locations;
in response to determining that the medical history associated with the patient includes one or more locations in the set of locations, selecting a first location from the medical history based on one or more of the following preferences:
active locations are preferred for selection over inactive locations;
locations where the patient has been treated more recently are preferred for selection over locations where the patient has been treated less recently; and
locations treating the patient type of the patient having a higher predetermined priority are preferred for selection over locations treating patient types having a lower predetermined priority;
in response to determining that the medical history of the patient does not include any locations in the set of locations, setting the first location as unspecified.

27. The system of claim 25, the instructions for determining the first provider for the patient further comprising instructions for:
determining whether a preferred provider is associated with the patient in the practice management system;
in response to determining that a preferred provider is associated with the patient in the practice management system, selecting the preferred provider as the first provider;
in response to determining that a preferred provider is not associated with the patient in the practice management system, determining whether a medical history associated with the patient includes any providers in the set of providers;
in response to determining that the medical history associated with the patient includes one or more providers in the set of providers, selecting a first provider from the medical history based on one or more of the following preferences:
active providers are preferred for selection over inactive providers;
providers who have treated the patient more recently are preferred for selection over providers who have treated the patient less recently; and
providers treating the patient type of the patient having a higher predetermined priority are preferred for selection over providers treating patient types having a lower predetermined priority;
in response to determining that the medical history of the patient does not include any providers in the set of providers, setting the first provider as unspecified.

28. The system of claim 25, the instructions for determining the first provider for the patient further comprising instructions for:
determining whether a preferred provider is associated with the patient in the practice management system;
in response to determining that a preferred provider is associated with the patient in the practice management system, selecting the preferred provider as the first provider;
in response to determining that a preferred provider is not associated with the patient in the practice management system, determining whether a medical history associated with the patient includes any providers in the set of providers;
in response to determining that the medical history associated with the patient includes one or more providers in the set of providers, selecting a first provider from the medical history based on one or more of the following preferences:
active providers are preferred for selection over inactive providers;
providers who have treated the patient more frequently are preferred for selection over providers who have treated the patient less frequently; and
providers treating the patient type of the patient having a higher predetermined priority are preferred for selection over providers treating patient types having a lower predetermined priority;
in response to determining that the medical history of the patient does not include any providers in the set of providers, setting the first provider as unspecified.

29. The system of claim 25, the instructions for determining the second location in response to the transfer status indicating that the first provider wants appointments for existing patients of the first provider to be scheduled with the first provider further comprising instructions for:
determining a second set of active locations comprising each active location that is currently scheduling for the first location;
determining a subset of the set of active locations, each active location corresponding to the first provider;
determining a set of active locations comprising the intersection of the subset of active locations corresponding to the first location and the subset of active locations corresponding to the first provider; and
selecting the second location from the set of active locations comprising the intersection of the subset of active locations corresponding to the first location and the subset of active locations corresponding to the first provider, wherein the selection of the second location is based on a predetermined priority of locations in the set active locations, and wherein the predetermined priority of the first location is the highest priority.

30. The system of claim 25, the instructions for determining the second provider and the second location in response to the transfer status indicating that the first provider wants appointments for existing patients of the first provider to be scheduled with a second provider further comprising instructions for:
determining a second set of active locations comprising each active location that is currently scheduling for the first location;
determining a second set of active providers comprising each active provider that has a transfer status indicating that the provider will schedule appointments for patients of the primary patient type associated with another provider; and
selecting as the second location a location from the second set of active locations at which at least one of the second set of active providers is actively scheduling patients, giving preference to the locations having the highest priority;
selecting as the second provider a location from the second set of active providers that is currently scheduling appointments at the second location for the primary patient type.

31. The system of claim 25, wherein the determination of the first location and/or the determination of the second location is based on at least a portion of an address associated with the patient being mapped to a provider location.

32. The system of claim 25, further comprising instructions for, prior to determining the set of active providers:
resolving any duplicate providers from the set of health care providers;
resolving any duplicate locations from the set of locations that provide health care services; and/or
resolving any duplicate patient codes from data of the practice management system.

33. The system of claim 25, wherein the instructions for determining a first provider further comprise instructions for:
determining whether an event in a medical history of the practice management system associated with the patient includes a provider code;
in response to determining that the event does not include a provider code, determining provider information from any notes in the medical history that correspond to the event; and
in response to determining that the event notes include provider information, associating the corresponding provider with the event.

34. The system of claim 25, wherein the instructions for determining a first location further comprise instructions for:
determining whether an event in a medical history of the practice management system associated with the patient includes a location code;
in response to determining that the event does not include a location code, determining location information from any notes in the medical history that correspond to the event; and
in response to determining that the event notes include location information, associating the corresponding location with the event.

35. The system of claim 25, wherein the patient is disqualified in the patient reactivation system from being contacted for scheduling a future appointment in response to an indication that the provider and location to which the patient is routed does not represent a schedule which should be filled by the patient activation system.

36. The system of claim 25, further comprising instructions for, prior to routing the patient to a provider and/or location:
determining whether a remote location indication is associated with the first location, wherein the remote location indication indicates that treating the patient at the first location has priority over the first provider treating the patient;
in response to determining that the remote location indication is associated with the first location and the first provider is not presently scheduling appointments at the first location for the primary patient type, routing the patient to the first location and a second provider who is presently scheduling appointments at the first location for the primary patient type.
